(19) United States
(12) Patent Application Publication
(10) Pub. No.: US 2008/0221859 A1
(43) Pub. Date: Sep. 11, 2008

(54) Emulation Mode for Emulating Optical Record Medium Types

(75) Inventor: Jurgen Mario Van Geel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/064,084

(22) PCT Filed: Aug. 21, 2006
(86) PCT No.: PCT/IB06/52882

§ 371 Date: Feb. 19, 2008

(30) Foreign Application Priority Data
Aug. 22, 2005 (EP) 05107663.6

(51) Int. Cl. G06F 9/455

(52) U.S. Cl. 703/24

(57) ABSTRACT

In summary, when new optical record media types become available in the market that are not supported by the optical drive 530 a user has, in addition to upgrading the existing optical drive to be able to read/write these new optical record media types, the host application that is being used to read/write optical record media will have to be updated. This problem is solved by providing a method to operate the optical drive 530 in an emulation mode for emulating different optical record media types. The emulation feature allows using the existing application that can handle an old optical record media type to be used on new optical record media. Additionally, the emulation feature allows designing host applications for newer type of optical record media that become available by using the existing old optical record media types.

The present invention relates to a method of operating an optical drive in an emulation mode.

The invention further relates to a computer program product, the computer program product after being loaded onto an optical drive, providing the optical drive with the capability to operate in an emulation mode.

The invention further relates to a computer readable medium comprising such a computer program product.

The invention further relates to a system for operating an optical drive in an emulation mode.

When new optical record medium types become available in the market that are not supported by the optical drive a user has, the user will have to upgrade his optical drive to support these new optical record medium types. Also, the user is forced to upgrade his existing host application installed so that the upgraded host application can handle the new optical record medium types correctly. The upgraded host application will then support the new type of optical record medium and the new features of the new optical record medium. For example, a single layer DVD optical record medium is typically 4.7 GB in size whereas a single layer Blu-ray optical record medium is typically 27 GB in size. Hence the host application running on the optical drive should be able to handle this size feature correctly. This means that when new optical record medium types become available in the market that are not supported by the optical drive a user has, in addition to upgrading the existing optical drive to be able to read/write these new optical record medium types, the host application that is being used to read/write optical record mediums will also have to be updated. Hence to use the new optical record medium types that become available in the market that are not supported by the optical drive a user has, the user has to purchase a new optical drive supporting the new optical record medium type and additionally has to spend money for buying a host application that supports the new optical record medium type to use the optical drive to its full potential. For example host applications like Nero burning ROM or easy CD/DVD creator have to be updated for handling Blu-ray type of optical record media.

JP 2000311066 discloses an embodiment of an emulation method that makes it possible to make disk shaped optical record medium such as a CD or a DVD accessible instead of tape shaped recording media by reproducing the data image from the installed disk shaped optical record medium. When a data recovery instruction assuming a magnetic tape device is given, an input-output emulating part gives an instruction to a disk shaped optical record medium and prepares for reading data from the installed disk shaped optical recording medium. Then the data image of a file group saved from this disk shaped optical record medium is read and transferred to a device. When transfer of the data image is finished, the input-output emulating part executes readout completion. In this way, the data image is reproduced. Here the method allows disk shaped recording medium to be read instead of a tape shaped recording media. An instruction is given to read a magnetic tape but an emulation unit gives an instruction to a disk shaped optical record medium and thus reads data from the disk shaped optical record medium. In case the disk shaped optical record medium is a CD and the host application that is being used is Nero Burning ROM and you have a new disk shaped optical record medium which is a Blu-ray optical record medium, then this method is not able to emulate the CD as a Blu-ray optical record medium and use the Nero Burning ROM on the emulated Blu-ray optical record medium.

The object of the invention is to provide a method for handling different optical record media types by a host application. This object is achieved by providing a method according to the opening paragraph for emulating a first type of optical record medium when a second type of optical record medium is loaded onto the optical drive, the method comprising the steps of:

receiving a first access command for accessing the first type of optical record medium,

translating the received first access command for accessing the first type of optical record medium into a second access command for accessing the second type of optical record medium,

accessing the second type of optical record medium using the second access command.

Having an emulation feature allows using an existing application that can handle an old optical record medium type to be used on new optical record media that become available in the market. Further, the emulation feature makes it possible to design host applications for newer type of optical record media that will become available in the market by using the existing old optical record medium that is already available.

An embodiment of the method of operating an optical drive in an emulation mode further comprises receiving an emulation command, instructing that the second type of optical record medium is to be emulated as the first type of optical record medium.

Having an explicit emulation command gives the advantage to the user to specify which type of optical record medium is to be emulated as which other type of optical record medium.

In a second embodiment of the method of operating an optical drive in an emulation mode according to the invention, the method comprises:

dividing the second type of optical record medium into a plurality of virtual optical record media of the first type,

specifying a virtual optical record medium of the plurality of virtual optical record media of the first type to be accessed with the first access command.

This allows multiple volume emulation. This has the advantage that it allows emulation of an optical record medium with a higher size capacity to be emulated as a plurality of optical record media with a lower size capacity. Further, even though there are pluralities of virtual optical record media, the host application has information on only one optical record medium that is emulated.

It is an object of the invention to provide a computer program product for handling different optical record media types by a host application. This object is achieved by providing a computer program product according to the opening paragraph to be loaded onto an optical drive, providing said optical drive a capability to emulate a first type of optical record medium when a second type of optical record medium is loaded onto the optical drive, by carrying out the following tasks:

receiving a first access command for accessing the first type of optical record medium,

translating the received first access command for accessing the first type of optical record medium into a second access command for accessing the second type of optical record medium,

accessing the second type of optical record medium using the second access command.

An embodiment of the computer program product further provides the optical drive the capability to carry out the further task of receiving an emulation command, instructing that the second type of optical record medium is to be emulated as the first type of optical record medium.

In a second embodiment of the computer program product, the computer program product further provides the optical drive the capability to carry out the following further tasks:

dividing the second type of optical record medium into a plurality of virtual optical record media of the first type,

specifying a virtual optical record medium of the plurality of virtual optical record media of the first type to be accessed with the first access command.

It is to be noted that the computer program product achieves the same advantages as described with respect to the method.

It is an object of the invention to provide a computer readable medium comprising such a computer program product for handling different optical record media types by a host application. Further, the computer readable medium comprising the computer program product can be on a remote database, which can be accessed over a network. Storing the computer program product on a remote database has the advantage that the computer program product can be made use of by a number of users or by the same user whenever a user wants to operate his/her optical drive in an emulation mode. The computer program product after being downloaded from the remote database on to the optical drive, provides the optical drive with a capability to emulate a first type of optical record medium when a second type of optical record medium is loaded onto the optical drive.

It is an object of the invention to provide a system for handling different optical record media types by a host application. This object is achieved by providing a system according to the opening paragraph for emulating a first type of optical record medium when a second type of optical record medium is loaded onto the optical drive, the system comprising:

receiving means arranged to receive a first access command for accessing the first type of optical record medium,

translation means arranged to translate the received first access command for accessing the first type of optical record medium into a second access command for accessing the second type of optical record medium,

accessing means arranged to access the second type of optical record medium using the second access command.

An embodiment of the system for operating an optical drive in an emulation mode further comprises instructing means arranged to receive an emulation command instructing that the second type of optical record medium is to be emulated as the first type of optical record medium.

In a second embodiment of the system for operating an optical drive in an emulation mode to emulate a first type of optical record medium when a second type of optical record medium is loaded onto the optical drive, the system comprises:

dividing means arranged to divide the second type of optical record medium into a plurality of virtual optical record media of the first type,

specifying means arranged to specify a virtual optical record media of the plurality of virtual optical record media of the first type to be accessed with the first access command.

It is to be noted that the object of the invention is achieved by providing a method and a system for handling different optical record media types by an application wherein the system has the same advantages as the methods.

These and other aspects of the invention will be apparent from the embodiments described in the following description and with reference to the accompanying drawings in which,

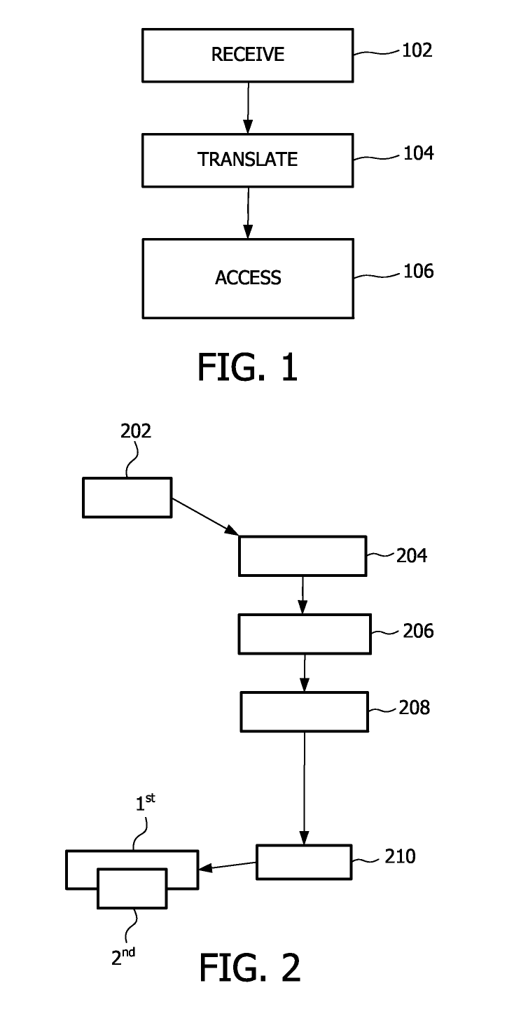

FIG. 1 shows a simplified flowchart illustrating the method of operating an optical drive in an emulation mode according to the invention,

FIG. 2 show illustrations of emulating a DVD type of optical record medium as a CD type of optical record medium and emulating a DVD type of optical record medium as a Blu-ray type of optical record medium,

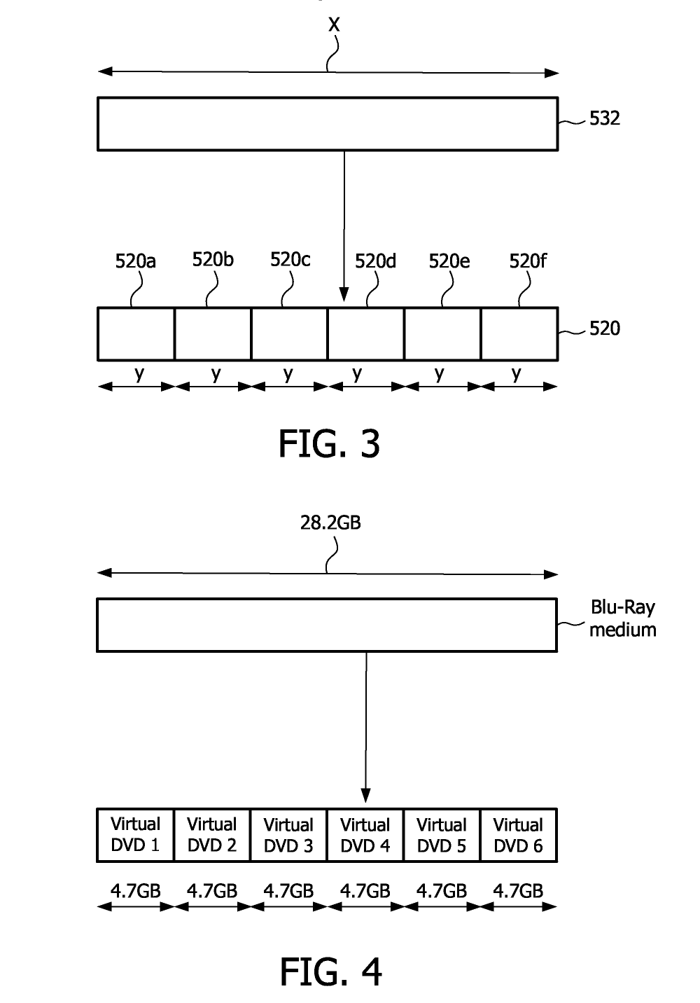

FIG. 3 shows a second embodiment of the method according to the invention,

FIG. 4 shows an illustration of the second embodiment of the method wherein a blu-ray type of optical record medium is emulated as DVD type of optical record medium,

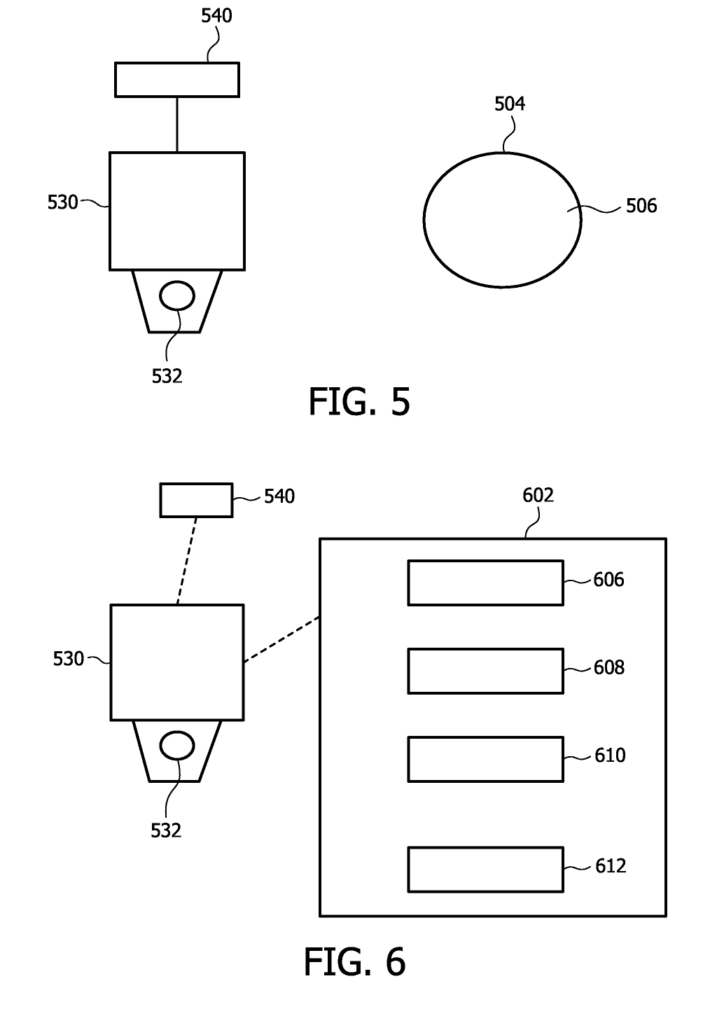

FIG. 5 shows a computer program product for operating an optical drive in an emulation mode,

FIG. 6 shows a first embodiment of the system for operating an optical drive in an emulation mode,

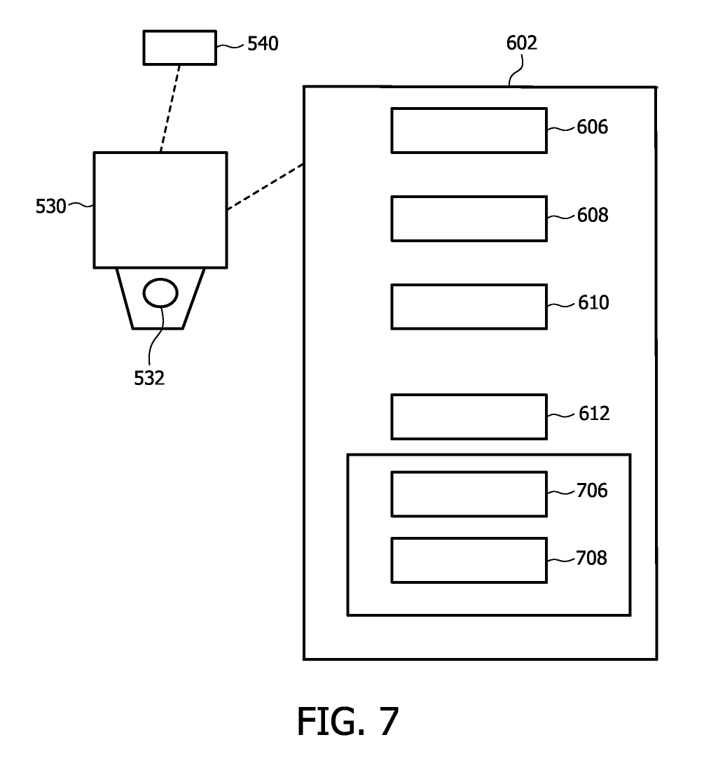

FIG. 7 shows a second embodiment of the system for operating an optical drive in an emulation mode.

FIG. 1 shows a simplified flowchart illustrating the method of operating an optical drive in an emulation mode according to the invention where a second type of optical record medium that is loaded onto the optical drive is emulated as a first type of optical record medium. In step 102 a first access command is received to access the first type of optical record medium. In step 104 the received first type of access command is translated into a second access command for accessing the second type of optical record medium. In step 106 the second type of optical record medium is accessed using the second access command. The method further comprises receiving an emulation command instructing that the second type of optical record medium that is loaded onto the optical drive is to be emulated as the first type of optical record medium. Having such an explicit command gives the advantage to the user to specify which type of optical record medium is to be emulated as which other type of optical record medium.

FIG. 2 shows an illustration of emulating a DVD 2^{nd} type of optical record medium as a CD 1^{st} type of optical record medium. The user has an application for CD 1^{st} type of optical record medium and the user can use his CD application on the DVD 2^{nd} type of optical record medium by emulating DVD 2^{nd} type as a CD 1^{st} type. This means that this emulation feature allows the older, CD 1^{st} type existing application to be used on the newer type, DVD 2^{nd} type of optical record media. In FIG. 2, 202 represents an application suitable for handling CD 1^{st} type of optical record medium. By emulating a DVD 2^{nd} type of optical record medium as a CD 1^{st} type of optical record medium, the emulation feature allows a user to use this existing CD application 202 on a new DVD 2^{nd} type of optical record medium. In step 204 an emulation command is received instructing that 2^{nd} type of DVD optical record medium that is loaded onto the optical drive is to be emulated as 1^{st} type of CD optical record medium, which is an optional step. In step 206 a first access command is received to access the first type of optical record medium, which is an access command to access a CD. In step 208 the received first type of CD access command is translated into a second type of DVD access command for accessing the second type of DVD optical record medium. In step 210 the second type of DVD optical record medium is accessed using the second type of DVD access command. From this illustration it is clear that a user will be able to use his older applications on newer optical record media types.

In an other illustration of FIG. 2, new applications for new type of optical record media are to be designed and the new type of optical record media are not yet available in the market. Only the features of the new optical record media are known. The existing old applications cannot handle the features of the new optical record media. This is solved by emulating an existing old type of optical record medium as a new type of optical record medium which is yet to be released into the market in future. This emulation feature allows designing new applications for the new optical record media to be released into the market using the old optical record media types. In FIG. 2, 202 represents the new application suitable for handling Blu-ray type of optical record medium. In step 204 an emulation command is received instructing that second type of DVD optical record medium that is loaded onto the optical drive is to be emulated as first type of Blu-ray optical record medium which is an optional step. In step 206 a first access command is received to access the first type of optical record medium, which is a Blu-ray command. In step 208 the received first type of Blu-ray access command is translated into a second DVD access command for accessing the second type of DVD optical record medium. In step 210 the second type of DVD optical record medium is accessed using the second DVD access command. By emulating a DVD 2^{nd} type of optical record medium as a Blu-ray 1^{st} type of optical record medium, it allows an application designer to start designing applications for Blu-ray optical record medium by using the available type of optical record medium, which is a DVD. From this illustration it is clear that it is possible to emulate an existing older optical record medium as a newer optical record medium. It is important to note that only specifications of the new optical record media may be available but not the physical media itself. This enables the application manufacturers to start designing, manufacturing and selling newer applications for the new optical record media types before the new optical record media becomes available in the market. Users can purchase such new applications and start using the new applications on the existing old optical record media types.

FIG. 3 shows a first embodiment of the method according to the invention, the method comprising dividing the second type of optical record medium that is loaded onto the optical drive into a plurality of virtual optical record media of the first type and specifying a virtual optical record medium of the plurality of virtual optical record media of the first type to be accessed with the first access command. FIG. 3 shows an optical record medium 520 of the first type that is emulated when a second type of optical record medium 532 is loaded onto the optical drive. This second type of optical record medium 532 has a capacity of X GB., and is to be emulated as the optical record medium of a first type 520, which has a lower size capacity of Y GB. Since the emulated optical record medium of first type 520 has a lower capacity of size, the host applications will behave erroneously as they might not know how to handle an optical record medium 532 with a higher capacity size. Hence, in this embodiment the concept of multiple volume emulation is made use of. In this embodiment, second type of optical record medium 532 is divided into a plurality of virtual optical record media each of Y GB. Each of the virtual optical record media preferably represents an entire optical record medium of the emulated first type of optical record medium 520. After dividing the second type of optical record medium into a plurality of virtual optical record media of the first type, the application can specify which virtual optical record media it wants to access and after that the optical drive will appear to have accessed an optical record medium of first type of size Y GB. The other remaining virtual optical record media will remain hidden until the application specifies it wants to access another virtual optical record media. This means that the second type of optical record medium 532 that is loaded onto the optical drive is divided into virtual optical record media namely 520a, 520b, 520c, 520d, 520e and 520f as shown in FIG. 3, wherein each virtual optical record media represent an entire first type of optical record medium 520. Here we have 6 virtual optical record media namely 520a, 520b, 520c, 520d, 520e and 520f. The application can specify that virtual optical record medium 520d is to be accessed. After specifying this, the optical drive will access virtual optical record media 520d and the remaining virtual optical record media 520a, 520b, 520c, 520e and 520f will remain hidden until the host application specifies it wants to access another virtual optical record media. This is illustrated with an example in FIG. 4. In FIG. 4 a Blu-ray type of optical record medium is emulated as a DVD type of optical record medium. Here a Blu-ray type of optical record medium having a capacity of 28.2 GB is emulated as a DVD type of optical record medium having a size of 4.7 GB. Since the application does not know how to handle a DVD type of optical record medium with a capacity of 28.2 GB, the application will behave erroneously. This is overcome by dividing the Blu-ray optical record medium into 6 virtual DVD of 4.7 GB each, each one of which preferably represents an entire DVD type of optical record medium. The host application can specify which virtual DVD optical record media it wants to access. For example, if the host application specifies to access virtual DVD optical record media 4, then after specifying this the optical drive will appear to have accessed the virtual DVD 4 of 4.7 GB size and the other virtual DVD 1, 2, 3 5 and 6 will remain hidden until the host application specifies it wants to access another virtual DVD. It should be noted that the number of virtual discs here is dependent on the size of the optical record medium that is loaded onto the optical drive. For example, there are 25 GB Blu-ray discs. In such a case, only 5 virtual DVD discs will be hosted. The number of virtual discs is something that needs to be determined by the optical drive depending on the size of the optical record medium that is loaded. For example, if a 30GB Blu-ray disc is emulated as a DVD, then the 30 GB Blu-ray disc is divided into 6 virtual DVD of 4.7 GB size each, and the remaining space of 1.8 GB is treated as a DVD of size 1.8 GB and accessed. Alternatively, the virtual DVD of size less than 4.7 GB can be discarded and not accessed by the host application. It is important to note that the host application that is mentioned here may be different than the application to read/write discs. For example a user may use application software A (for example. Philips emulation control software) to enable emulation and use application software B (for example Nero Burning ROM) to actually burn the optical record media. This embodiment has the advantage of allowing emulation of an optical record medium with a higher capacity size to be emulated as a plurality of optical record media with a lower size capacity.

FIG. 5 shows a computer program product 506 for operating an optical drive in an emulation mode. This computer program product 506 is the host software to control the settings of an optical drive and emulate the emulation mode. In FIG. 5, 530 is the optical drive, 532 is the 2^{nd} type of optical record medium that is loaded onto the optical drive, 540 is a host computing unit and 506 is a computer program product for operating the optical drive 530 in an emulation mode. 504 is a computer readable medium comprising the computer program product 506. The computer program product 506 is loaded onto the optical drive 530. The computer program product 506 after being loaded onto the optical drive 530 provides the optical drive the ability to operate in an emulation mode by carrying out the following tasks:

receiving a first access command for accessing the first type of optical record medium,

translating the received first access command for accessing the first type of optical record medium into a second access command for accessing the second type of optical record medium,

accessing the second type of optical record medium (532) using the second access command.

An embodiment of the computer program product 506 further provides the optical drive 530 the capability to carry out the further task of receiving an emulation command, instructing that the second type of optical record medium (532) is to be emulated as the first type of optical record medium. In a second embodiment of the computer program product 506, the computer program product 506 further provides the optical drive 530 the capability to carry out the following further tasks of:

dividing the second type of optical record medium (532) into a plurality of virtual optical record media (520a,520b,520c,520d, 520e,520f) of the first type (520), specifying a virtual optical record medium (520d) of the plurality of virtual optical record media (520a,520b,520c,520d,520e,520f) of the first type (520) to be accessed with the first access command.

The computer program product 506 can be made available on a computer readable medium 504 (See FIG. 5) or on a record carrier such as CD, DVD, DVD+RW, Blu-ray or any other means. Further, the computer program product 506 can be stored on a remote database. Users who want to operate their optical drive in an emulation mode for emulating optical record medium types can download the computer program product 506 from the remote database onto their optical drive 530 and operate their optical drive in an emulation mode. To this end, the optical drive will have an interface through a network to access the computer program product 506 on the remote database. Alternatively, users who want to operate their optical drive 530 in an emulation mode for emulating optical record medium types can purchase this computer readable medium 504.

FIG. 6 shows a first embodiment of the system for operating an optical drive in an emulation mode where a first type of optical record medium is emulated when a second type of optical record medium is loaded onto the optical drive 530. Elements that have the same construction and function as in FIG. 5 are designated by the same reference numeral and not explained in detail. In FIG. 6, 602 is the system that enables the optical drive 530 to operate in an emulation mode. A second type of optical record medium 532 is loaded onto the optical drive 530. This optical record medium 532 has to be emulated as first type of optical record medium. The optical drive 530 is arranged to receive commands from a host computing unit 540. The system 602 for operating the optical drive 530 is an emulation mode comprises:

receiving means (608) arranged to receive a first access command for accessing the first type of optical record medium,

translation means (610) arranged to translate the received first access command for accessing the first type of optical record medium into a second access command for accessing the second type of optical record medium,

accessing means (612) arranged to access the second type of optical record medium (532) using the second access command.

The system 602 further comprises instructing means 606 arranged to receive an emulation command instructing that the second type of optical record medium that is loaded onto the optical drive is to be emulated as the first type of optical record medium. This command is received at first before the start of the emulation mode.

FIG. 7 shows a second embodiment of the system for operating an optical drive in an emulation mode where a first type of optical record medium is emulated when a second type of optical record medium is loaded onto the optical drive. Elements that have the same construction and function as in FIG. 5 are designated by the same reference numeral and not explained in detail. In FIG. 7, 602 is the system that enables the optical drive 530 to operate in an emulation mode. A second type of optical record medium 532 is loaded onto the optical drive 530. This optical record medium 532 has to be emulated as first type of optical record medium. The optical drive 530 is arranged to receive commands from a host computing unit 540. The system 602 for operating the optical drive 530 in an emulation mode further comprises:

dividing means (706) arranged to divide the second type of optical record medium (532) into a plurality of virtual optical record media (520a,520b,520c,520d,520e,520f) of the first type(520),

specifying means (708) arranged to specify a virtual optical record media (520d) of the plurality (520a,520b,520c,520d,520e,520f) of virtual optical record media of the first type to be accessed with the first access command.

The embodiments described herewith illustrating the method of operating an optical drive 530 (See FIG. 5, FIG. 6 and FIG. 7) in an emulation mode can be incorporated in each of the optical drive during manufacturing of the optical drive itself. This allows the optical drive manufacturers to manufacture optical drives that offer the capability to operate the optical drive in an emulation mode. The manufactured optical drives will have the system which is inbuilt within the optical drive that enables the optical drive to operate in an emulation mode. This emulation mode allows the manufactured optical drives to emulate optical record medium types where a first type of optical record medium is emulated when a second type of optical record medium is loaded onto the optical drive. Alternatively, the computer readable medium 504 comprising the computer program product 506 can be purchased and loaded onto the optical drive 530 to enable the optical drive to operate in emulation mode and thereby emulate different optical record media types.

The order in the described embodiments of the method for operating an optical drive in an emulation mode is not mandatory, a person skilled in the art may change the order of steps without departing from the concept as intended by the present invention. Further, in the claims any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements and by means of a suitably programmed computer. In the system claims enumerating several means, several of these means can be embodied by one and the same item of computer readable software or hardware. The method of operating the optical drive in an emulation mode can be made available on any computer readable medium in the form of a computer program product. The means and steps in which the computer program product achieves the emulation is not mandatory. A person skilled in the art may change the order or the means to get the same emulation effect as intended by the present invention. Further, in the foregoing application, the invention has been described with reference to specific embodiments thereof. It will however be evident that various modifications and changes may be made without departing from the broader scope of the invention as set forth in the appended claims. The figures and description are accordingly, to be regarded for illustrative purposes than being used in the restrictive sense.

1. A method of operating an optical drive (530) in an emulation mode for emulating a first type of optical record medium when a second type of optical record medium (532) is loaded onto the optical drive comprising the steps of:
receiving (102) a first access command for accessing the first type of optical record medium,
translating (104) the received first access command for accessing the first type of optical record medium into a second access command for accessing the second type of optical record medium (532),
accessing (106) the second type of optical record medium (532) using the second access command.

2. A method as claimed in claim 1, the method further comprising receiving an emulation command preceding the steps of claim 1, instructing that the second type of optical record medium (532) is to be emulated as the first type of optical record medium.

3. A method as claimed in claim 1, the method further comprising:
dividing the second type of optical record medium (532) into a plurality of virtual optical record media (520a,520b,520c,520d,520e,520f) of the first type (520),
specifying a virtual optical record medium (520d) of the plurality of virtual optical record media (520a,520b,520c,520d,520e,520f) of the first type (520) to be accessed with the first access command.

4. A computer program product (506) to be loaded onto an optical drive (530), providing said optical drive a capability to emulate a first type of optical record medium when a second type of optical record medium (532) is loaded onto the optical drive carrying out the following tasks:
receiving (102) a first access command for accessing the first type of optical record medium,
translating (104) the received first access command for accessing the first type of optical record medium into a second access command for accessing the second type of optical record medium (532),
accessing (106) the second type of optical record medium (532) using the second access command.

5. A computer program product (506) as claimed in claim 4, the computer program product (506) further providing the optical drive (530) the capability to carry out the further task of receiving an emulation command preceding the steps of claim 4, instructing that the second type of optical record medium (532) is to be emulated as the first type of optical record medium.

6. A computer program product (506) as claimed in claim 4, the computer program product (506) further providing the optical drive (530) the capability to carry out the following tasks:
dividing the second type of optical record medium (532) into a plurality of virtual optical record media (520a,520b,520c,520d, 520e,520f) of the first type(520),
specifying a virtual optical record medium (520d) of the plurality of virtual optical record media (520a,520b,520c,520d,520e,520f) of the first type (520) to be accessed with the first access command.

7. A computer readable medium (504) comprising a computer program product (506) as claimed in claim 4.

8. A system (602) for operating an optical storage drive (530) in an emulation mode to emulate a first type of optical record medium when a second type of optical record medium (532) is loaded onto the optical drive (530), the system comprising:
receiving means (608) arranged to receive a first access command for accessing the first type of optical record medium,
translation means (610) arranged to translate the received first access command for accessing the first type of optical record medium into a second access command for accessing the second type of optical record medium,
accessing means (612) arranged to access the second type of optical record medium (532) using the second access command.

9. A system (602) for operating an optical storage drive (530) in an emulation mode to emulate a first type of optical record medium when a second type of optical record medium (532) is loaded onto the optical drive (530), the system comprising:
receiving means (608) arranged to receive a first access command for accessing the first type of optical record medium,
translation means (610) arranged to translate the received first access command for accessing the first type of optical record medium into a second access command for accessing the second type of optical record medium,
accessing means (612) arranged to access the second type of optical record, medium (532) using the second access command, the system further comprising instructing means (606) arranged to receive an emulation command preceding the steps of claim 1 instructing that the second type of optical record medium (532) is to be emulated as the first type of optical record medium.

10. A system (602) as claimed in claim 8, the system 602 further comprising:
dividing means (706) arranged to divide the second type of optical record medium (532) into a plurality of virtual optical record media (520a,520b,520c,520d,520e,520f) of the first type(520),
specifying means (708) arranged to specify a virtual optical record media (520d) of the plurality (520a,520b,520c,520d,520e,520f) of virtual optical record media of the first type to be accessed with the first access command.
